(19) United States
(12) Patent Application Publication
(10) Pub. No.: US 2009/0141206 A1
(43) Pub. Date: Jun. 4, 2009

(54) LIQUID CRYSTAL COMPOSITION AND LIQUID CRYSTAL DISPLAY HAVING THE SAME

(75) Inventors: Duck-Jong SUH, Seoul (KR); Won-Gap Yoon, Seoul (KR); Nam-Seok Lee, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/326,732

(22) Filed: Dec. 2, 2008

(30) Foreign Application Priority Data
Dec. 3, 2007 (KR) 10-2007-0124150
Sep. 24, 2008 (KR) 10-2008-93778

(51) Int. Cl. G02F 1/136; C09K 19/30; C09K 19/12

(52) U.S. Cl. 349/42; 252/299.63; 252/299.66

(57) ABSTRACT

A liquid crystal display device with a chip on glass (COG) structure is disclosed. The liquid crystal display device includes a liquid crystal panel including a liquid crystal layer. The liquid crystal composition includes more than 0% and less than or equal to 15% by weight of at least one first polar liquid crystal compound according to formula 1 or 2:

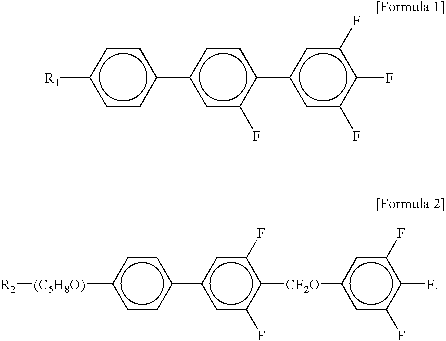

R₁ is an alkyl group having 2-5 carbons, an alkoxy group having 2-5 carbons, or an alkenyl group having 2-5 carbons, and R₂ is an alkyl group having 2-5 carbons or an alkenyl group having 2-5 carbons.

### CROSS-REFERENCE TO RELATED APPLICATIONS

This application claims priority from and the benefit of Korean Patent Application No. 10-2007-0124150, filed on Dec. 3, 2007, and Korean Patent Application No. 10-2008-93778, filed on Sep. 24, 2008, which are both hereby incorporated by reference for all purposes as if fully set forth herein.

### BACKGROUND OF THE INVENTION

1. Field of the Invention

The present invention relates to a liquid crystal composition and a liquid crystal display (LCD) device including the same. In particular, the present invention relates to a liquid crystal composition that may provide for reduced power consumption and improved response speed, and an LCD device including the same.

2. Discussion of the Background

The advent of an information-oriented society has led to a need for high performance displaying devices that can rapidly display various kinds of information, such as images, graphics, letters, etc., which has led to rapid growth of the display-related industries.

In recent years, an LCD device has gained popularity as a next generation display because it is lighter, slimmer, and has lower power consumption than a cathode ray tube (CRT). Such an LCD device has been widely employed for electronic watches, electronic calculators, personal computers (PCs), TVs, and the like. In particular, a large-screen LCD device and a large-screen plasma display panel (PDP) device, for example, having a size of more than 30 inches, have been highlighted as displays for high-definition digital broadcasting.

An LCD device includes two substrates and a liquid crystal layer disposed therebetween. The LCD device displays images when the alignment of liquid crystal molecules is altered by an electric field between the two substrates.

An LCD device should be slim and light for more convenience in portability, for example, when used in small, compact computers, such as laptop computers and Ultra Mobile Personal Computers (UMPCs). However, making the LCD device slimmer and lighter may lead to performance degradation, such as a shortened battery time and a decreased response speed. Accordingly, there is a need for an LCD device having both decreased power consumption and improved response speed.

### SUMMARY OF THE INVENTION

The present invention provides a liquid crystal composition that may provide for reduced power consumption and simultaneously improve response speed.

The present invention also provides an LCD device including the liquid crystal composition.

Additional features of the invention will be set forth in the description which follows, and in part will be apparent from the description, or may be learned by practice of the invention.

The present invention discloses a liquid crystal display device including a liquid crystal panel having a display region and non-display region located in at least one side of the display region, a flexible printed circuit connected to one part of the non-display region, a plurality of first data drive ICs and second data drive ICs arranged in the non-display region, and a plurality of first data signal lines sequentially connected to the data drive ICs, and a plurality of second data signal lines sequentially connected to the second data drive ICs. The first data drive ICs are coupled to each other in series, and the second data drive ICs are coupled to each other in series.

The liquid crystal panel has a liquid crystal layer consisting of liquid crystal composition. The liquid crystal composition comprises more than 0% and less than or equal to 15% by weight of at least one first polar liquid crystal compound according to formula 1 or 2:

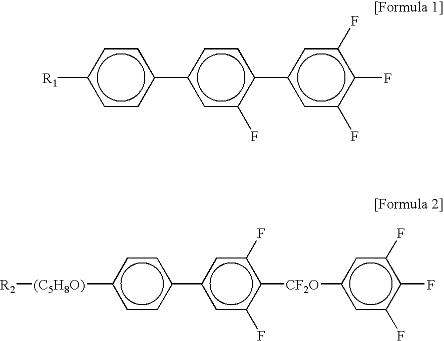

R₁ is an alkyl group having 2-5 carbons, an alkoxy group having 2-5 carbons, or an alkenyl group, having 2-5 carbons, and R₂ is an alkyl group having 2-5 carbons or an alkenyl group, having 2-5 carbons.

R₁ is an alkyl group having 2-5 carbons, an alkoxy group having 2-5 carbons, or an alkenyl group having 2-5 carbons, and R₂ is an alkyl group having 2-5 carbons or an alkenyl group having 2-5 carbons.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing an LCD display device according to an exemplary embodiment of the present invention.

FIG. 2A is a plan view showing a wiring configuration of the LCD panel of FIG. 1 according to an exemplary embodiment of the present invention.

FIG. 2B is a top view of the wiring configuration of the LCD panel of FIG. 2A.

FIG. 3A is a plan view showing a wiring configuration of the LCD panel of FIG. 1 according to another exemplary embodiment of the present invention.

FIG. 3B is a top view of the wiring configuration of the LCD panel of FIG. 3A.

FIG. 4 is a partial cross-sectional view showing an LCD device according to an exemplary embodiment of the present invention.

FIG. 5 is a graph showing a relationship between dielectric anisotropy and rotational viscosity according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

It will be understood that when an element such as a layer, film, region or substrate is referred to as being “on”, “connected to”, or “coupled to” another element or layer, it can be directly on, directly connected to, or directly coupled to the other element or layer, or intervening elements or layers may also be present. In contrast, when an element is referred to as being “directly on”, “directly connected to”, or “directly coupled to” another element or layer, there are no intervening elements or layers present.

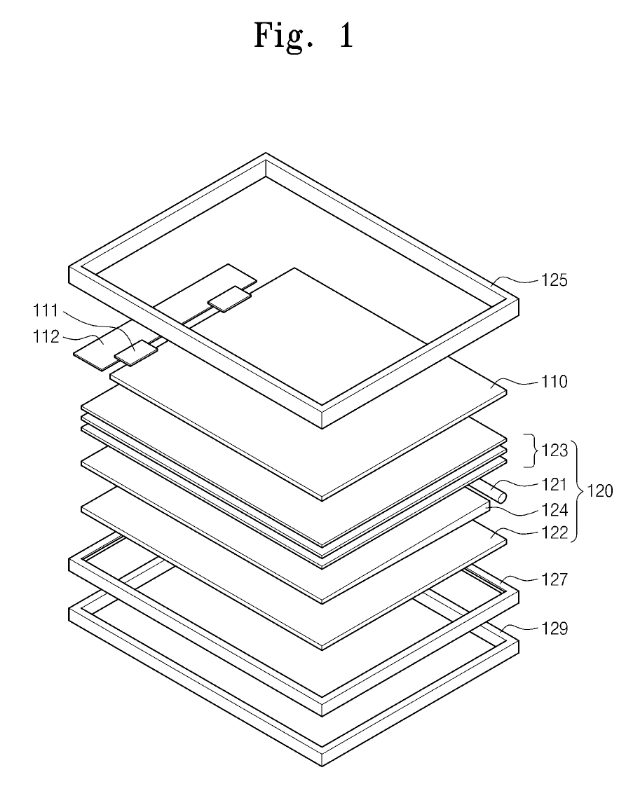

FIG. 1 is an exploded perspective view showing an LCD device according to an exemplary embodiment of the present invention.

In the exemplary embodiment of the present invention, the LCD device includes an LCD panel 110 to display images and a backlight unit 120 to provide light to the LCD panel 110.

The LCD panel 110 and the backlight unit 120 are disposed in a mold frame 127 and fixed to the mold frame 127 by an upper cover 125 pressing an edge of an upper surface of the LCD panel 110. In addition, a lower cover 129 is disposed under the mold fame 127 to support and protect the mold frame 127.

The backlight unit 120 includes a lamp 121 to emit light, a light guide plate 124 to guide the light from the lamp 121 to the LCD panel 110, and a plurality of optical sheets 123 to improve the quality of the light. The optical sheets 123 may include a diffusion sheet, a prism sheet, and/or a protection sheet.

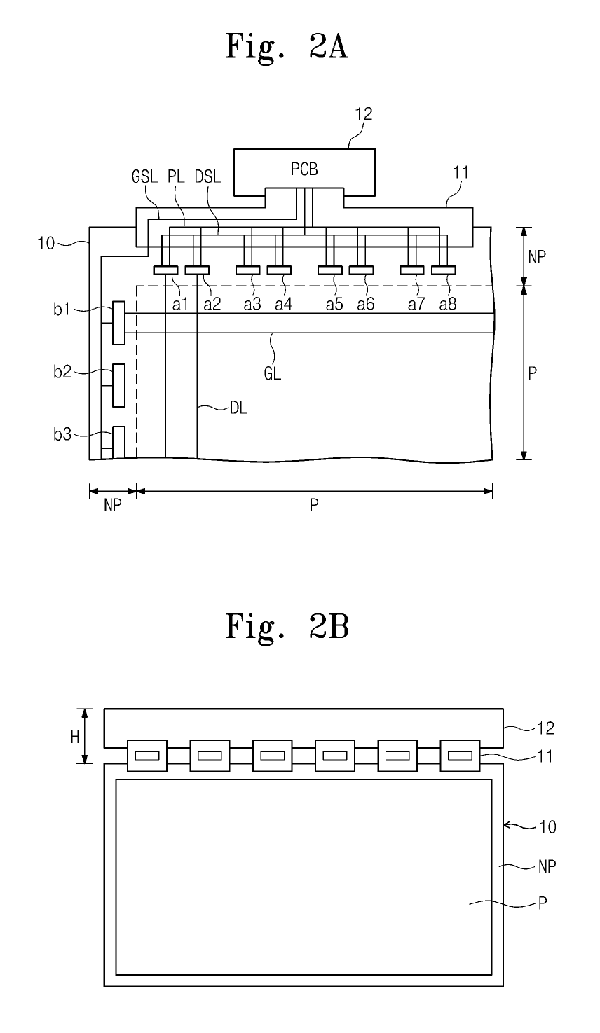

FIG. 2A is a plan view showing a wiring configuration of the LCD panel of FIG. 1 according to an exemplary embodiment of the present invention, and FIG. 2B is a top view showing the wiring configuration of the LCD panel of FIG. 2A.

As shown in FIG. 2A and FIG. 2B, the LCD panel includes a display region P in which images are displayed and a non-display region NP located adjacent to at least one side of the display region P.

A plurality of gate lines GL and a plurality of data lines DL crossing the gate lines GL are formed in the display region P to define a plurality of pixels. A plurality of gate drive ICs b1, b2, and b3 to operate the gate lines GL and a plurality of data drive ICs a1, a2, a3, a4, a5, a6, a7, and a8 to operate the data lines DL are formed in the non-display region NP so images may be displayed in the display region P.

A flexible printed circuit (FPC) board 11 is connected to one part of the non-display region NP. Particularly, one end of FPC board 11 is connected to one part of the non-display region NP connected with the data drive ICs a1, a2, a3, a4, a5, a6, a7, and a8. The other end of the FPC board 11 is connected to a printed circuit board (PCB) 12. A power controller (not shown) and a timing controller (not shown) are formed on the PCB 12. The power controller controls a power of the pixel. The timing controller outputs a gate signal to the gate drive ICs b1, b2, and b3 and a data signal to the data drive ICs a1, a2, a3, a4, a5, a6, a7, and a8. A gate signal line GSL and a data/gamma signal line DSL, which transfers a signals from the timing controller to the gate drive IC b1, b2, and b2 and the data drive IC a1, a2, a3, a4, a5, a6, a7, and a8, respectively, and a power line PL are formed on the FPC board 11 and in the non-display region NP of the LCD panel 110. There may be more gate lines, data lines, and the drive ICs than are shown in FIG. 2A.

The LCD device has a chip on glass (COG) structure of which the gate drive ICs b1, b2, and b3 and the data drive ICs a1, a2, a3, a4, a5, a6, a7, and a8 are formed on a for the LCD panel 211. In this COG structure, as power and signals are transferred through the FPC board 11, the size of the FPC board 11 may be bigger than that of a conventional LCD device. In addition, a double-layer structure may be used in the FPC board 11, which may limit the manner in which the lines may be arranged. Moreover, the COG type LCD panel needs many flexible printed circuit boards to connect the FPC board 11 to each data drive IC a1, a2, a3, a4, a5, a6, a7, and a8 and a space in which the FPC board 11 may be mounted. Therefore, because recent LCD devices may be very thin and small, the fact that a width H of the PCB 12 should be more than 15 mm may cause the PCB 11 to collide with a hinge region of the LCD device. As a result, more space may be needed for the LCD device.

In the present exemplary embodiment, a cascade structure is used, which provides data signals by connecting the FPC board 11 to a part of the non-display region NP and the signals from the FPC board 11 are provided to each data drive IC coupled in parallel thereto by shifting operation of the data drive ICs.

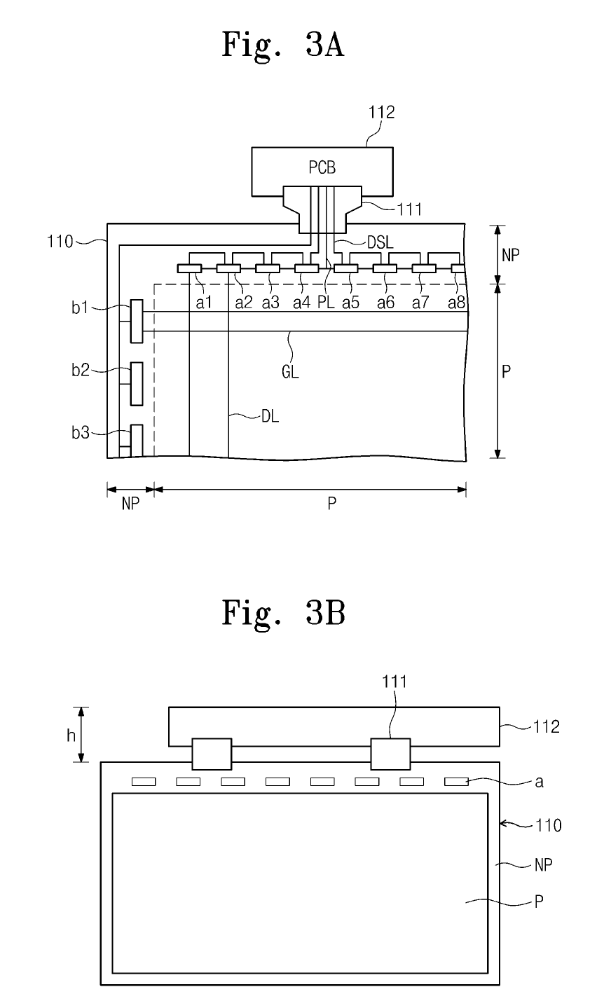

FIG. 3A is a plan view showing a wiring configuration of the LCD of FIG. 1 according to another exemplary embodiment of the present invention, and FIG. 3B is a top view showing the wiring configuration of the LCD panel of FIG. 3A.

As shown in FIG. 3A and FIG. 3B, a LCD panel 110 includes a display region P to display images and a non-display region NP located adjacent to least one side of the display region P.

A plurality of gate lines GL and a plurality of data lines DL the gate line GL are formed in the display region P to define a plurality of pixels. A plurality of gate drive ICs b1, b2, and b3 to operate the gate lines GL and a plurality of data drive ICs a1, a2, a3, a4, a5, a6, a7, and a8 to operate the data lines DL respectively are arranged in the non-display region NP in order to apply image signals to the pixels in the display region P.

One end of a flexible printed circuit (FPC) board 111 is connected to a portion of non-display region NP between the fourth data drive IC a4 and the fifth data drive IC a5, and the other end of the FPC board 111 is connected to a printed circuit board (PCB) 112. The data drive ICs a1, a2, a3, a4, a5, a6, a7, and a8 are arranged in the non-display region NP and to the left and right of a central portion of the FPC board's 111 location.

A power controller (not shown) and a timing controller (not shown) are formed on the PCB 112. The power controller controls a power of the pixel. The timing controller (not shown) outputs a gate signal to the gate drive ICs b1, b2, and b3 and a data signal to the data drive ICs a1, a2, a3, a4, a5, a6, a7, and a8. A gate signal line GSL and a data/gamma signal line DSL, which respectively transfer the signals from the timing controller to the gate drive ICs b1, b2, and b3 and the data drive ICs a1, a2, a3, a4, a5, a6, a7, and a8, and a power line PL formed on the FPC board 111 and in the non-display region NP of the LCD panel 110. One part of the data signal lines DSL is sequentially connected to the data drive ICs a1, a2, a3, and a4, which are coupled to each other in series and arranged towards the left of the FPC board 111, and the other part of the data signal lines DSL are sequentially connected to the data drive ICs a5, a6, a7, and a8, which are coupled to each other in series and arranged towards the right of the FPC board 111. It should be understood that more gate lines GL, data lines DL, gate signal lines GSL, and data/gamma signal lines DSL may be formed than what are shown in the FIG. 3A because FIG. 3A only shows a portion of them for convenience.

A data/gamma signal applied to the fourth data drive IC a4 is shifted from the fourth data drive IC a4 to the third data drive IC a3, so that it is applied to the third data drive IC a3. The data/gamma signal applied to the fifth drive IC a5 is shifted from the fifth data drive IC a5 to the sixth data drive IC a6 so that it is applied to the sixth data drive IC a6. The data/gamma signals are sequentially applied to each of the data drive ICs in the same way.

In the cascade type LCD panel, it may be possible to reduce the size of the FPC board 111 because the FPC board 111 does not need to be connected to each of the data drive ICs a1, a2, a3, a4, a5, a6, a7, and a8, which may reduce the number of the lines. In addition, because the number of power/signal lines may be reduced, the FPC board 111 may have a single layer structure. Therefore, not only the size of the FPC board 111 but also the number of the FPC board 111 may be reduced. Consequently, the width of the PCB is reduced to about 10 mm, thereby providing a very slim product. For example, when the width of the PCB is about 10 mm, the LCD panel and the PCB may be located in the same plane.

As the power and data/gamma signal are transferred through the lines in the cascade type, a voltage drop and a signal's delay of the signals transferred through the lines may occur when the resistance of the power line and the signal line is high. Thus, it is necessary to reduce the resistance of the lines. In the present exemplary embodiment, each line has a triple layer structure of molybdenum-aluminum-molybdenum (Mo—Al—Mo) in order to reduce the resistance of the line. Each line having the triple layer structure of Mo—Al—Mo has a resistance 4.6 times smaller than that of a line having a single layer structure of Chromium (Cr). Moreover, an undercut may occur when using a single layer line of Chromium, so the line may be vulnerable to high temperature and high humidity.

An LCD device having the COG structure may need a timing controller to provide signals in a cascade mode, and a data drive IC that has an operating device therein adjusted in to the cascade mode. Due to the timing controller and the data drive IC, power consumption in the LCD device increases by about 10 to about 15% compared to that of the conventional LCD device.

Therefore, in the present exemplary embodiment, the liquid crystal composition is applied to the LCD device to offset the increased power consumption. That is, the LCD device employing the COG structure may be operated stably, even when providing the same power as the conventional LCD device.

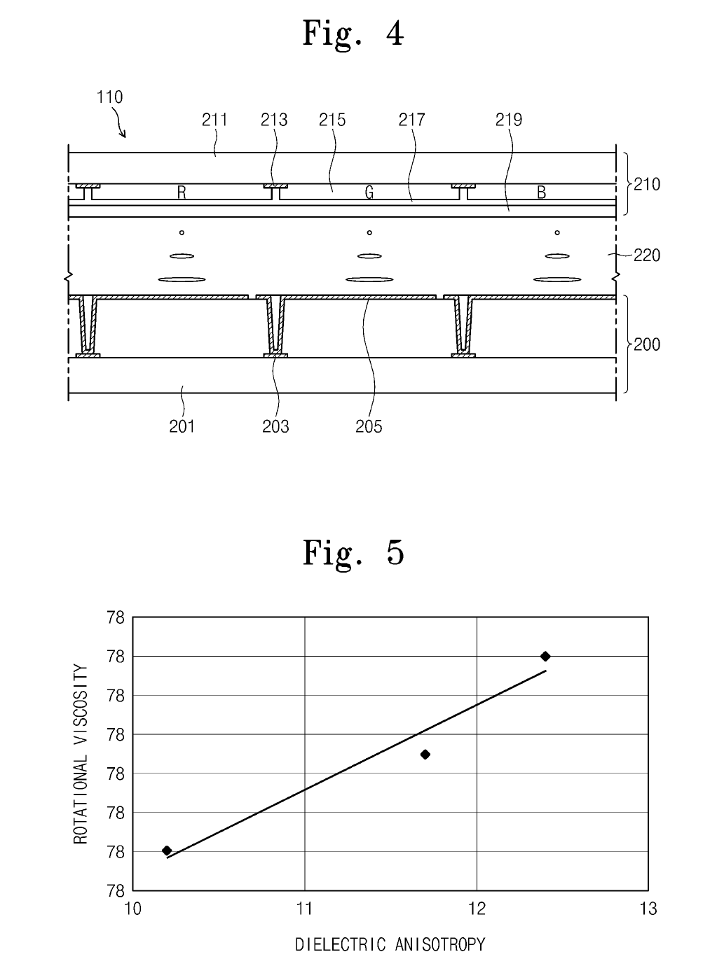

Referring to FIG. 4, the LCD device 110 includes a first substrate 200, a second substrate 210, and a liquid crystal layer having liquid crystal composition 220 disposed between the second substrate 210 and the first substrate 200.

The first substrate 200 includes a plurality of pixels arranged in a matrix on a second insulating substrate 201. Each pixel includes a thin film transistor (TFT) 203 and a pixel electrode 205. The TFT 203 is connected to a data line, which transmits a data signal, and a gate line, which transmits a gate signal. The pixel electrode 205 is connected to the TFT 203.

The TFT 203 selectively supplies a data signal from the data line to the pixel electrode 205 in response to a gate signal. The TFT 203 includes a gate electrode connected to the gate line, a source electrode connected to the data line, and a drain electrode connected to the pixel electrode 205. The TFT 203 further includes an activation layer and an ohmic contact layer (not shown). The activation layer overlaps the gate electrode, with a gate insulating layer (not shown) therebetween, and includes a channel between the source electrode and the drain electrode. The ohmic contact layer provides ohmic contacts between the activation layer, and the source electrode and the drain electrode.

A pixel electrode 205 is provided on each pixel region to overlap a color filter 215, such as a red color filter R, a green color filter G, and a blue color filter B. The pixel electrode 205 is connected to the drain electrode. A pixel data signal supplied through the TFT 203 gives rise to a potential difference between the pixel electrode 205 and a common electrode 219. The potential difference alters the alignment of the liquid crystal molecules. Light transmittance depends on the alignment of the liquid crystal molecules.

The second substrate 210 includes a first insulating substrate 211, a black matrix 213 disposed on the first insulating substrate 211 to prevent light leakage, the color filter 215 disposed on a region defined by the black matrix 213, an overcoat layer 217 disposed on the color filter 215 and the black matrix 213, and the common electrode 219 disposed on the overcoat layer 217.

The black matrix 213 may include an opaque organic material or a metal and defines a non-display region and prevents the TFT 203 from causing a current leakage.

The color filter 215 includes a red color filter R, a green color filter G, and a blue color filter B to display red, green, and blue, respectively. The red color filter R, the green color filter G, and the blue color filter B are provided on the upper side of the second substrate 210 to correspond to a red pixel, a green pixel, and a blue pixel, respectively, that are provided on the TFT 203. The color filter 215 reflects a specific wavelength of light depending on a pigment applied thereon to display a color corresponding to the pigment. Various colors may be implemented using additive mixtures of color stimuli.

The overcoat layer 217 is disposed on the black matrix 213 and the color filter 215 to protect the color filter 215 and reduce a step height between the black matrix 213 and the color filter 215. The overcoat layer 217 may include a transparent organic material.

The common electrode 219 is disposed on the overcoat layer 217. An electric field, which adjusts the light transmittance of the liquid crystal layer 220, may be generated across the liquid crystal layer 220 due to a difference between a common voltage applied to the common electrode 219 and a pixel voltage applied to the pixel electrode 205. Namely, the applied voltage is changed depending upon the liquid crystal composition. In the present exemplary embodiment, the liquid crystal composition is enabled to operate at a voltage level equal to or less than 4 V.

The liquid crystal composition may be operated when a voltage of about 3.0 V to about 3.6 V is applied. A voltage to operate the pixels may be the same as the voltage applied to the pixel electrode 205. A voltage of about 6.0 V to about 7.3 V may be applied to the drain electrode through the data line.

The liquid crystal composition may have a refractive index of about 0.98 to 0.11, when cell gap of the LCD panel may be 3.5 μm to 4.5 μm. Consequently, delay value Δnd of the liquid crystal layer 220 may be about 340˜495 nm.

The liquid crystal layer 220 may contain more than 0% and less than or equal to 15% by weight of at least one first polar liquid crystal compound according to formula 1 or 2:

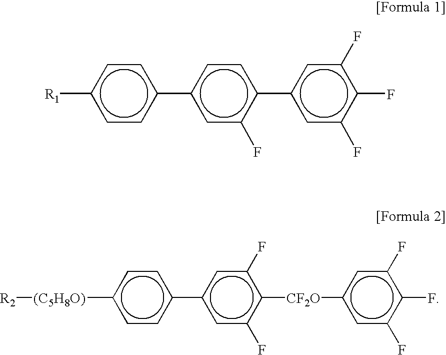

R₁ is an alkyl group having 2-5 carbons, an alkoxy group having 2-5 carbons, or an alkenyl group having 2-5 carbons, and R₂ is an alkyl group having 2-5 carbons or an alkenyl group having 2-5 carbons.

For example, the content of the first polar liquid crystal compound may be less than 15% by weight. When the content of the first polar liquid crystal compound is in excess of 15% by weight, it may be difficult to achieve a high response speed and long-term reliability of the liquid crystal panel.

Only when the liquid crystal composition has a dielectric anisotropy of 10.0 to 12.5 and a nematic isotropic transition state temperature Tni of more than 100° C., can the LCD device be ensured a contrast ratio of more than 90%, which is comparable to existing LCD panels with a driving voltage of more than 4 V. Rotational viscosity should be decreased to improve response speed. However, the rotational viscosity tends to increase as the dielectric anisotropy increases. Therefore, it is not easy to achieve an excellent contrast ratio in a low voltage driving environment.

Referring to FIG. 5, which shows the relationship between dielectric anisotropy and rotational viscosity, it can be seen the dielectric anisotropy generally has a linear relationship with the rotational viscosity. For example, when the dielectric anisotropies are 10.4, 11.7, and 12.4, the corresponding rotational viscosities are 80, 85, and 90 mPas, respectively. This shows that the rotational viscosity increases as the dielectric anisotropy increases. Lowering the rotational viscosity to improve the response speed may make the dielectric anisotropy lower, which in turn may deteriorate the contrast ratio. Therefore, the conventional liquid crystal compositions may not achieve both an excellent response speed and contrast ratio at the same time in a low voltage driving environment. The liquid crystal composition according to the exemplary embodiment of the present invention may improve both the response speed and the contrast ratio, even in a low voltage driving environment.

According to the exemplary embodiment of the present invention, the liquid crystal layer 220 may further contain 25-40% by weight of at least one first non-polar liquid crystal compound according to formula 3, 4, or 5:

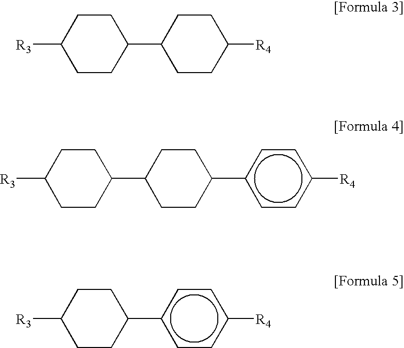

R₃ is to an alkyl group having 3 or more carbons or an alkenyl group having 3 or more carbons, and R₄ is an alkyl group having 3 or more carbons or an alkenyl group having 3 or more carbons.

The first non-polar liquid crystal compound may have low viscosity. The first non-polar liquid crystal compound may be 25-40% by weight of the liquid crystal layer 220. When the content of the first non-polar liquid crystal compound is less than 25% by weight, it may be difficult to achieve a sufficient response speed. When the content of the first non-polar liquid crystal compound is more than 40% by weight, the response speed may be improved, but it may be difficult to achieve a sufficient contrast ratio since the dielectric anisotropy of the liquid crystal composition is reduced.

Apart from the first polar liquid crystal compound, the liquid crystal layer 220 may further contain at least one second polar liquid crystal compound according to formula 6:

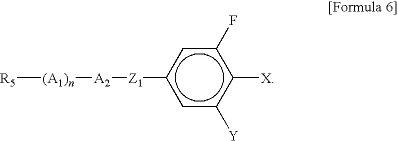

R₅ is an alkyl group, an alkoxy group, or an alkenyl group, A₁ is 1,4-cyclohexylene or 1,4-phenylene, A₂ is 1,4-cyclohexylene, 1,4-phenylene, 5-fluoro-1,4-phenylene, or 3-5-difluoro-1,4-phenylene, Z₁ is a single bond or CF₂O, X is F or OCF₃, Y is H or F, and n is 1 or 2.

The content of the first polar liquid crystal compound and the second polar liquid crystal compound may be 35-60% by weight.

When the content of the first polar liquid crystal compound and the second polar liquid crystal compound is less than 35% by weight, the dielectric anisotropy may be lowered, which in turn could deteriorate display quality of the panel. On the contrary, when the content is more than 60% by weight, it may be difficult to achieve a high response speed and long-term reliability of the LCD panel.

Alternatively, the liquid crystal layer 220 may further contain a second non-polar liquid crystal compound according to formula 7, along with the first non-polar liquid crystal compound:

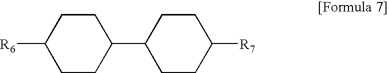

R₆ is an alkyl group having 2 or less carbons or an alkenyl group having 2 or less carbons, and R₇ is an alkyl group having 2 or less carbons or an alkenyl group having 2 or less carbons.

The first non-polar liquid crystal compound and the second non-polar liquid crystal compound may make up 25-60% by weight in the liquid crystal layer 220. When the content is less than 25% by weight, the dielectric anisotropy may increase excessively, which may cause image sticking in the LCD panel and deteriorate long-term reliability. When the content is more than 60% by weight, the dielectric anisotropy may decrease excessively, which may make it difficult to acquire sufficiently low black brightness and achieve an appropriate contrast ratio, thus deteriorating the display quality of the LCD panel.

The above composition may have a refractive index of 0.1 to 0.12, a dielectric anisotropy of 10 to 12.5, and the rotational viscosity of 80 to 90 mPas. This could improve both the response speed and the contrast ratio even in a low voltage driving environment.

Experimental Example

Liquid crystal compositions having the compositions shown in Table 1 and the properties shown in Table 2 were synthesized, and LCD devices described in Experimental Examples 1 and 2 were manufactured using the liquid crystal compositions. The gap between cells in the LCD device was 4.0 mm.

TABLE 1

| | | Experimental | Experimental |
|---|---|---|---|
| | | Example 1 | Example 2 |
| | Composition | (% by weight) | (% by weight) |
| Non-polar compound | 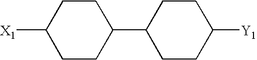 | 29 | 27.5 |
| | 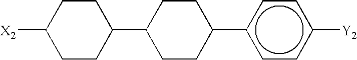 | 15 | 17 |
| | 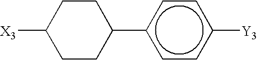 | 5 | 4.5 |
| Polar compound | 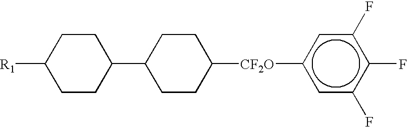 | 14.5 | 15 |
| | 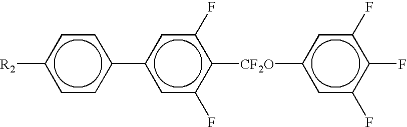 | 15 | 15 |
| | 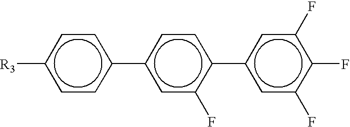 | 8.5 | 9 |
| | 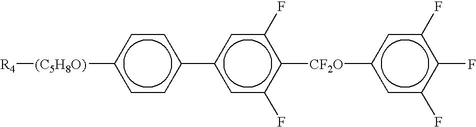 | 13 | 12 |

In Table 1, X₁, X₂, and X₃ are hydrocarbon groups, each having more than 3 carbons, Y₁, Y₂, and Y₃ are alkyl groups or alkenyl groups, and R₁, R₂, R₃, and R₄ are alkyl groups or alkenyl groups.

TABLE 2

| | Experimental | |
|---|---|---|
| Item | Example 1 | Experimental Example 2 |
| Rotational viscosity | 85 mPas | 85 mPas |
| Phase transition temperature | 75° C. | 75° C. |
| Dielectric anisotropy | 11 | 11 |
| Refractive index | 0.12 | 0.12 |

In the LCD device described in Experimental Examples 1 and 2, the response speed and contrast ratio were measured t the driving voltage of 3.3 V. A result showed that the response speed and contrast ratio of the LCD device were 14.9 ms and 750:1 in Experimental Example 1, and 14.1 ms and 950:1 in Experimental Example 2, respectively.

As described above, when the liquid crystal composition of Experimental Example 1 or 2 is applied to a COG structure of an LCD device, the additional power consumption caused by the COG structure may be compensated by the low voltage operating liquid crystal composition, so that the LCD device may be operated stably.

It will be apparent to those skilled in the art that various modifications and variation can be made in the present invention without departing from the spirit or scope of the invention. For example, the liquid crystal composition of the present invention is optimized to the cascade type COG structure drawn in FIG. 3, but, if necessary, can be used to the COG structure drawn in FIG. 2 or to different structure. Thus, it is intended that the present invention cover the modifications and variations of this invention provided they come within the scope of the appended claims and their equivalents.

What is claimed is:

1. A liquid crystal display device, comprising:
a liquid crystal panel comprising a display region and non-display region, the non-display region being located adjacent to at least one side of the display region;
a flexible printed circuit connected to the non-display region;
a plurality of first data drive ICs and second data drive IC's arranged in the non-display region; and
a plurality of first data signal lines sequentially connected to the first data drive ICs, the first data drive ICs being coupled to each other in series, and a plurality of second data signal lines sequentially connected to the second data drive ICs, the second data drive ICs being coupled to each other in series,
wherein the liquid crystal panel comprises a liquid crystal layer consisting of a liquid crystal composition, and the liquid crystal composition comprises more than 0% and less than or equal to 15% by weight of at least one first polar liquid crystal compound according to formula 1 or2: 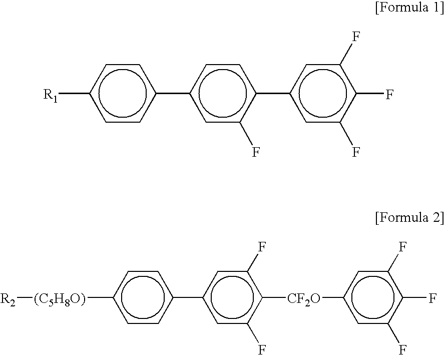
wherein R₁ is an alkyl group having 2-5 carbons, an alkoxy group having 2-5 carbons, or an alkenyl group having 2-5 carbons, and R₂ is an alkyl group having 2-5 carbons or an alkenyl group having 2-5 carbons.

2. The liquid crystal display device of claim 1, wherein the liquid crystal composition further comprises 25-40% by weight of at least one first non-polar liquid crystal compound according to formula 3, 4, or 5: 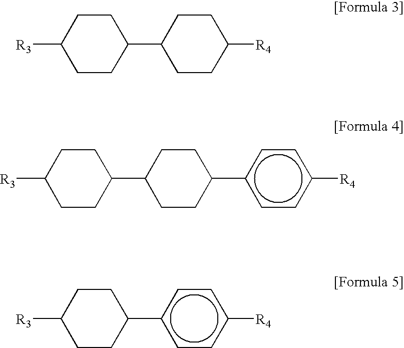
wherein R₃ is an alkyl group having 3 or more carbons or an alkenyl group having 3 or more carbons, and R₄ is an alkyl group having 3 or more carbons or an alkenyl group having 3 or more carbons.

3. The liquid crystal display device of claim 1, wherein the liquid crystal composition further comprises at least one second polar liquid crystal compound according to formula 6: 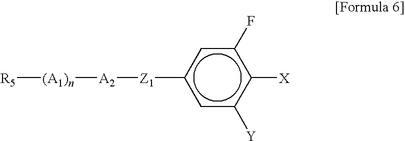
wherein R₅ is an alkyl group, an alkoxy group, or an alkenyl group, A₁ is 1,4-cyclohexylene or 1,4-phenylene, A₂ is 1,4-cyclohexylene, 1,4-phenylene, 5-fluoro-1,4-phenylene, or 3-5-difluoro-1,4-phenylene, Z₁ is a single bond or CF₂O, X is F or OCF₃, Y is H or F, and n is 1 or 2, and
wherein the total content of the first polar liquid crystal compound and the second polar liquid crystal compound is 35-60% by weight.

4. The liquid crystal display device of claim 2, wherein the liquid crystal composition further comprises a second non-polar liquid crystal compound according to formula 7: 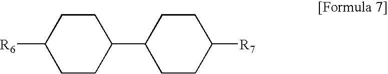
wherein R₆ is an alkyl group having 2 or less carbons or an alkenyl group having 2 or less carbons, and R₇ is an alkyl group having 2 or less carbons or an alkenyl group having 2 or less carbons, and
wherein the total content of the first non-polar liquid crystal compound and the second non-polar liquid crystal compound is 25-60% by weight.

5. The liquid crystal display device of claim 1, wherein each data signal line has a triple layer structure of molybdenum-aluminum-molybdenum (Mo—Al—Mo).

6. The liquid crystal display device of claim 1, wherein a dielectric anisotropy of the liquid crystal composition is 10 to 12.5.

7. The liquid crystal display device of claim 1, wherein a refractive index of the liquid crystal composition is 0.1 to 0.12.

8. The liquid crystal display device of claim 1, wherein a rotational viscosity of the liquid crystal composition is 80 to 90 mPas.

9. The liquid crystal display device of claim 1, wherein the liquid crystal panel further comprises a first substrate and a second substrate facing the first substrate, the liquid crystal layer is disposed the first substrate and the second substrate, the first substrate comprises a thin film transistor array and a pixel electrode, and the second substrate comprises a common electrode.

10. The liquid crystal display device of claim 9, wherein a cell gap between the first and the second substrates is 3.5 μm to 4.5μm.

11. The liquid crystal display device of claim 9, wherein an operating voltage applied to the pixel electrode in order to operate the liquid crystal layer is 3.0 V to 3.6 V.

12. A liquid crystal composition, comprising more than 0% and less than or equal to 15% by weight of at least one first polar liquid crystal compound according to formula 1 or 2: 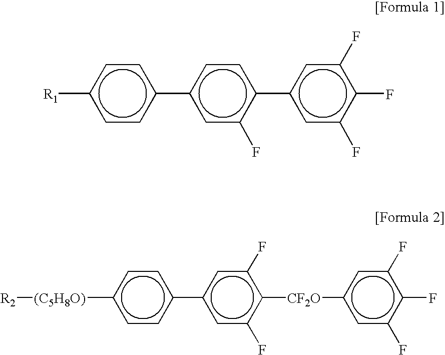
wherein R₁ is an alkyl group having 2-5 carbons, an alkoxy group having 2-5 carbons, or an alkenyl group having 2-5 carbons, and R₂ is an alkyl group having 2-5 carbons or an alkenyl group having 2-5 carbons.

13. The liquid crystal composition of claim 12, wherein
the liquid crystal composition further comprises 25-40% by weight of at least one first non-polar liquid crystal compound according to formulas 3, 4, or 5: 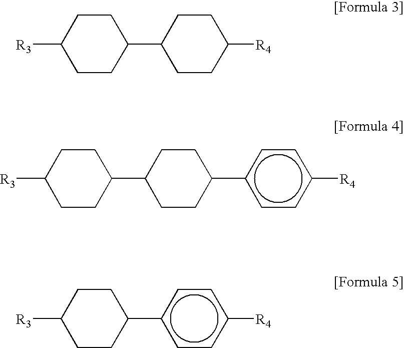
wherein R₃ is an alkyl group having 3 or more carbons or an alkenyl group having 3 or more carbons, and R₄ is an alkyl group having 3 or more carbons or an alkenyl group having3 or more carbons.

14. The liquid crystal composition of claim 8, wherein
the liquid crystal composition further comprises at least one second polar liquid crystal compound according to formula 6: 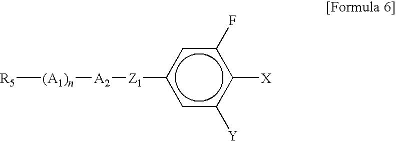
wherein R₅ is an alkyl group, an alkoxy group, or an alkenyl group, A₁ is 1,4-cyclohexylene or 1,4-phenylene, A₂ is 1,4-cyclohexylene, 1,4-phenylene, 5-fluoro-1,4-phenylene, or 3-5-difluoro-1,4-phenylene, Z₁ is a single bond or CF₂O, X is F or OCF₃, Y is H or F, and n is 1 or 2, and
wherein the total content of the first polar liquid crystal compound and the second polar liquid crystal compound is 35-60% by weight.

15. The liquid crystal composition of claim 9, wherein the liquid crystal composition further comprises a second non-polar liquid crystal compound according to formula 7: 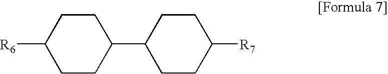
wherein R₆ is an alkyl group having 2 or less carbons or an alkenyl group having 2 or less carbons, and R₇ is an alkyl group having 2 or less carbons or an alkenyl group having 2 or less carbons, and
wherein the total content of the first non-polar liquid crystal compound and the second non-polar liquid crystal compound is 25-60% by weight.

16. The liquid crystal composition of claim 8, wherein a dielectric anisotropy of the liquid crystal composition is 10 to 12.5.

17. The liquid crystal composition of claim 8, wherein a refractive index of the liquid crystal composition is 0.1 to 0.12.

18. The liquid crystal composition of claim 8, wherein a rotational viscosity of the liquid crystal composition is 80 to 90 mPas.
